(19) United States
(12) Patent Application Publication
(10) Pub. No.: US 2006/0053367 A1
(43) Pub. Date: Mar. 9, 2006

(54) Customization method and system for authoring web pages

(76) Inventors: Eric Chen, Taipei City (TW); Li-Chun Hou, Taipei (TW); Yu-Ru Chou, Taipei City (TW)

Correspondence Address: BIRCH STEWART KOLASCH & BIRCH, PO BOX 747, FALLS CHURCH, VA, 22040-0747, US

(21) Appl. No.: 10/935,079

(22) Filed: Sep. 8, 2004

(51) Int. Cl. G06F 17/24

(52) U.S. Cl. 715/513; 715/516

(57) ABSTRACT

A customization method and system enable a user to author or simulate one or more web pages flexibly and specially for an Internet appliance. The customization method and device provide the user with some predefined general devices and a plurality of capacities associated therewith. The user can acquire a customized device by selecting or adding one of the predefined general devices and further editing or previewing the associated capacities. In addition, the user authors or previews the web page based on the customized device that is similar to the Internet appliance.

### BACKGROUND OF THE INVENTION

1. Field of the Invention

The invention relates generally to a customization method and system for authoring a web page. In particular, the invention relates to a customization method and system for authoring a web page to display on a web accessing device.

2. Background of the Invention

As the number of devices accessing the World Wide Web (referred to herein as “web”) proliferates, web content and applications need to be tailored to suit the characteristics of each device. These devices can include Internet Appliance (IA), but not limited to, such as wireless communication devices, personal digital assistants, desktop or laptop computers, or any combination of these items. Typically these devices have online capability. However, there are issues about content display due to hardware and software implementation. Take Internet Phone as an example for consideration:

Hardware—Screen Size vs. Layout Issue:

For design and usability issue, a large screen display like PC is not applied to all IA devices. Therefore, there are limitations for browsing regular Web pages. When too many contents in one regular Web page are displayed in a small screen, users must feel uncomfortable to read.

Hardware—Color Resolution Support.

In addition to user devices screens of different sizes and resolutions, these screens vary in their video capabilities and color resolution, or lack thereof. Again, in order for a web site to attract the largest number of potential users it must also deal with user devices that may not have video capability and color as well as those that do. Again, no known hardware or software allows the web site to handle such a wide variation in screens and other capabilities.

Hardware—Page Capacity:

Usually, there is size limitation for IA page download. The connection may be cut off if the page size is too large.

Hardware—Scrolling Web Pages Ability vs. Text Wrap Issue:

Not all IA devices are with touch screen or touch pan for scrolling big Web pages. So there is a text wrap issue—limitation for the maximum number of characters of one line.

Hardware—Audio or Multimedia Support

Different IA devices may support different audio or multimedia formats.

Hardware—Interaction:

Not all IA devices are with touch screen or touch pan for scrolling big Web pages. For example, in the case of a WAP capable telephone only a keypad and perhaps arrow keys are supplied due to the limited space. Not all devices have mouse like PC. The access keys of simple keyboard panel or buttons need to be specified.

Software—Web Browser vs. Markup Language Support:

In addition, there are many different Web browsers available in the IA devices, but not limited to, such as Internet Explorer, Netscape, Mozilla, Opera, Access, Slim, Avant, Safari, etc. Typically, these browser companies continue to release new versions that may support different tags of same markup languages. On the other hand, different browsers may not be able to parse all kinds of markup languages to display correct content on the devices. Furthermore, not all IA device manufactures adopt same Web browser with same version number.

Also, different Web browsers support different image file formats and different encoding methods.

With the issues aforementioned, it is time-consuming for content providers to carefully make different sets of Web contents for different IA devices. Generic contents authored and uploaded by the content providers are not in fashion. The content providers must author multitudes of specific contents (e.g. device dependent, service-provider dependent, or both of aforementioned dependent) for the variety of the mobile devices and service provider markets. Professional content providers need to make different sets of mobile Web contents even under the same mobile service. Actually, due to the growth in the global mobile phone manufacture markets, the software products of Web page authoring or those with mobile handset simulator aforementioned cannot catch up with the pace for each latest available handset in the mobile devices. Furthermore, the development of the software tools for web page authoring or mobile handset simulator will take too much effort for handing different mobile devices.

Following is reference of current mobile services in Japan and their related markup languages and illustrates how complicated conditions for the content providers to meet with:

| | The Name of | |
|---|---|---|
| The Name | Carrier Providers | |
| of Mobile | (Telecommunication | Markup |
| Service | Companies) | Languages |
| i-mode | NTT DoCoMo | cHTML/XHTML |
| Vodafone | Vodafone | HTML/MML/XHTML |
| live! | | |
| EZweb | au KDDI | HDML/XHTML |

### SUMMARY OF THE INVENTION

It is, therefore, a method and system of authoring one or more web pages are provided herein. The addition function of the customized device for authoring the web pages enables a user, especially a web content provider, to author the web pages flexibly. With customization method, the new device profile can be created based on existing devices the program supports. The customize device not only generate an editing mode which handles all limitation setting but also has functions of a simulator for fine-tuning the content layouts.

It is also, therefore, a customization method and system for authoring one or more web pages to display on Internet appliance are provided. The user authors the web pages with the web contents limited to the capacities of a hypothetic Internet appliance and a service provider associated therewith.

According to one aspect of the present invention, one embodiment of the present invention a customization method and system for authoring one or more web pages to display on a web accessing device, the system includes a plurality of predefined general devices for the web accessing device. Each predefined general device is with a plurality of capacities associated therewith. When a user selecting one of the predefined general devices as a base device is received, the system enables the user to edit at least one value corresponding one of the first capacities of the selected predefined general device. Then a customized device with a plurality of second capacities is generated. It is noted that at least one of the second capacities can be inherited from the first capacities and have the value corresponding thereto. Once the customized device is applied, an editorial zone, a simulator or both aforementioned are corresponding to said customized device and limited to at least one of the second capacities.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram illustrating a system associated with the authoring device according to one embodiment of the present invention;

FIG. 2 is a schematic flow chart illustrating one embodiment of authoring a web page in accordance with the present invention; and

FIGS. 3A TO 3D are schematic diagrams illustrating multitudes of user interface of one embodiment in accordance with this invention.

### DETAILED DESCRIPTION OF THE EMBODIMENTS

The following description provides specific details for a through understanding of, and enabling description for, embodiments of the invention. However, one skilled in the art will understand that the invention may be practiced without these detailed. In other instances, well known structures and functions have not been shown or described in detailed to avoid unnecessarily obscuring the description of the embodiments of the invention.

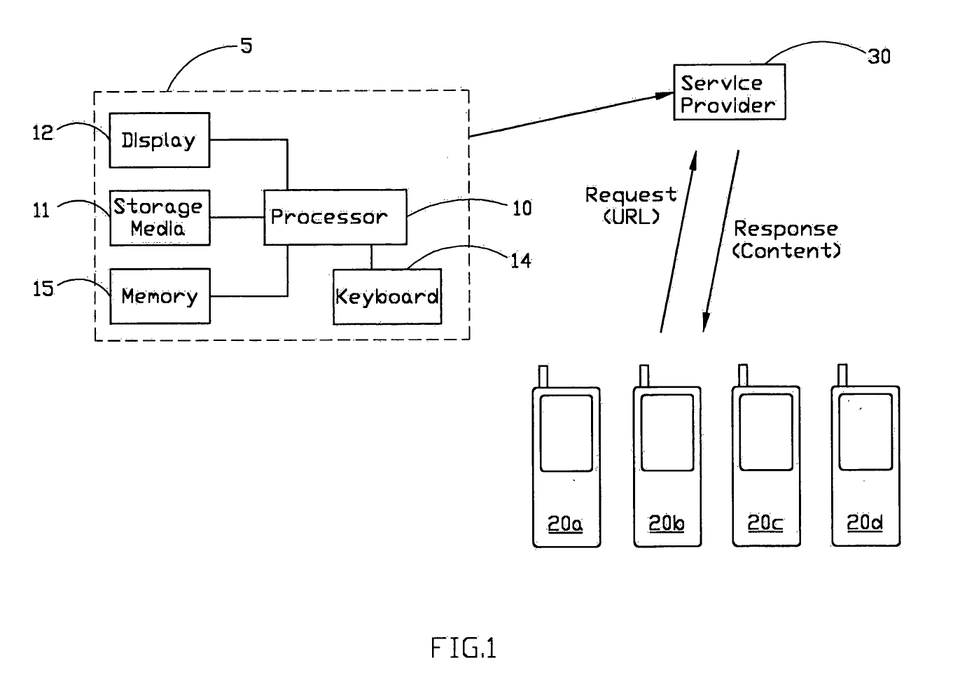

FIG. 1 illustrates a block diagram of one embodiment of a system of the present invention. The personal computer 5 is comprised of a processor 10 that controls the operation of the personal computer 5. Memory 15 is coupled to the processor 10 and configured to store data for display (e.g., video RAM) data that are being operated on by the processor 10, and processes to be executed. The memory 15 can include a semiconductor memory such as random access memory (RAM), read only memory (ROM), or FLASH RAM. Storage media 11 is configured to store data for longer-term storage. Examples of storage media 11 can include floppy disk drives, optical disk drives, hard drives, or any other type of storage media. The storage media 11 can be removable or fixed in the personal computer 5. An output device, such as a display 12 or monitor coupled to the processor 10, is configured to display information to the computer user. The display 12 may be a liquid crystal display (LCD), a cathode ray tube (CRT), or any other type of display.

The computer user, such as a content provider, can use a keyboard 14 to author or edit web contents to be executed by the processor 10 in generating desired information. In one embodiment, the keyboard 14 is a standard style keyboard with a mouse or trackball. The personal computer 5 of FIG. 1 is for illustration purposes only. The present invention is not limited to any one type of personal computer. Any personal computer capable of running the instructions required to accomplish the various embodiments of the present invention is encompassed by the present invention.

Unless described otherwise below, the construction and operation of the various blocks shown in FIG. 1 and the other Figures are of conventional design. As a result, such blocks need not be described in further detail beyond that provided herein, because they will be understood by those skilled in the relevant art. Such further detail is omitted for brevity and so as not to obscure the detailed description of the invention. Any modifications necessary to the blocks in FIG. 1 (or other Figures and embodiments) can be readily made by one skilled in the relevant art based on the detailed description provided herein.

A typical Internet appliance 20a, 20b, 20c or 20d, by way of example, the embodiments will be described with reference to the Internet appliance 20a, 20b, 20c, or 20d, such as mobile telephone, automobile-based web accessing device, or other communication devices with online capability. In a preferred embodiment, the Internet appliance 20a, 20b, 20c or 20d is a mobile telephone supporting a 2.5 G package communication system, such as PDC (Personal Digital Cellular) in Japan, or a 3 G package communication system, such as WCDMA and CDMA2000, or other communication system. Furthermore, the Internet appliance 20a, 20b, 20c or 20d may support a specific communication service which uses a specific communication standard. For example, in Japan, there are three main communication service providers: NTT DoCoMo, KDDI/au, and Vodafone, in which NTT DoCoMo uses wCDMA technology standard, KDDI/au uses the CDMA 2000-1x standard, and Vodafone also uses the wCDMA standard. Typically, the Internet appliance 20a, 20b, 20c or 20d supporting NTT DoCoMo service may not display the contents serviced by KDDI/au.

In addition, the Internet appliance 20a, 20b, 20c or 20d typically has a display screen (not shown) in which a web page is shown of fixed fonts, fixed spaces, fixed sizes, or fixed row of texts, etc. Furthermore, the Internet appliance 20a, 20b, 20c or 20d uses a built-in browser to view contents in the web page. However, the built-in browsers in the Internet appliance 20a, 20b, 20c and 20d have various versions different from each another. Different versions of the built-in browsers support different tags of markup languages. For example, the Internet appliances 20a and 20b have built-in browsers in the different versions, though Internet appliances 20a and 20b support same service provided by the same communication service provider. Thus, the display result of the contents in the web page is not identical for the Internet appliances 20a and 20b.

A typical service provider 30 is responsible for loading one or more web contents from one or more content providers and hosting software applications or web contents that are to be transmitted to and rendered by the Internet appliance 20a, 20b, 20c, or 20d. The various components, such as web contents, communicate using areas Internet protocols, but limited to, such as HyperText Transfer Protocol (HTTP), HTTP/TCP/IP, WAP/UDP/IP, or wHTTP/wTCP/IP. Typically, the Internet appliance 20a, 20b, 20c or 20d sends HTTP requests in company with its user agent to the service provider 30. Based on the user agent information, the service provider 30 with URL redirect mechanism should link to proper URL address and response for sending proper set of mobile contents to the Internet appliance 20a, 20b, 20c or 20d. However, different web contents from the personal computer 5, which support different communication service providers (not shown) may be stored in the identical service provider 30.

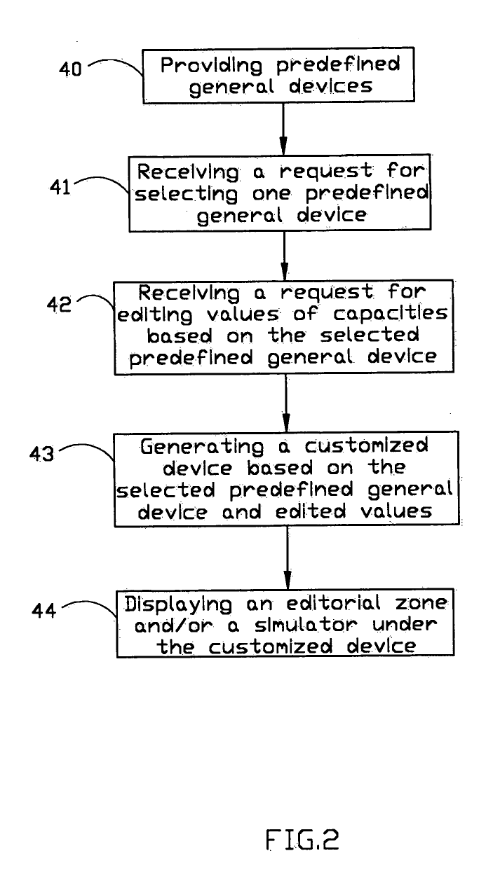

FIG. 2 illustrates a flowchart of one embodiment of the customization method of in accordance with the present invention. First, the content authoring system at the personal computer provides a digital record of one or more predefined general devices with respective capabilities (step 40). The content authoring system stores the digital record in the profile and display it on the output device of the personal computer for enabling a user, for a selected Internet appliance, to author a fit web page with web contents based on these predefined general devices.

In one embodiment, a set of capabilities corresponding one of the predefined general devices includes a subset of physical items related to physical capabilities of an Internet appliance, a subset of network items related to network capabilities of the Internet appliance, and a subset of software items related to software applications used in one typical service provider. For example, the physical capabilities of the Internet appliance are physical characteristics or properties of the Internet appliance, such as screen width, screen height, and screen color, etc. The network capabilities of the Internet appliance are communication characteristics or properties of the Internet appliance, such as built-in browser information (i.e. version), maximum size of received web page, extra tag supports, Emoji (icon) supporting, and received file format in a received web page. The software items for the typical service provider are the information of software application, such as software language interpreters/compilers, and encoding application, etc.

Next, the content authoring system receives a request that the user select one of the predefined general devices as a base device for editing or adding web page fitted thereto (step 41). There are preferences in performing the selection of a predefined general device. Basically, in order to design one or more web pages fit for displaying by a selected Internet appliance, a predefined general device of similar capacities as the selected Internet appliance is preferred. For example, the built-in browser associated with the selected predefined general device is similar as the selected Internet appliance. Furthermore, the Internet appliance associated with the predefined general device is same as the selected Internet appliance. Thus, the predefined general device is selected and provides with corresponding items based on which a web page is designated fit for displaying by the selected Internet appliance.

Once the predefined general device is selected, the associated set of capacities is shown and capable of being reset by the user. According the selected Internet appliance, the user may amend or modify values or setting of those capacities associated with the selected predefined general device, and then store these amended capacities with a customized device name. In addition, there are sets of values or settings recommended and provided by the content authoring system that has a variety of information or specification related to various Internet appliances and service providers.

For example, based on the selected predefined general device, the content authoring system enables the user to modify some physical items (step 42), such as the number of rows, the number of characters in a row, and the color resolution for displaying on the screen of the selected Internet appliance, etc. In addition, the content authoring system enables the user to modify some network items, such as the maximum value of byte count for a web page size, and the image or media file formats received by the selected Internet appliance, etc. Furthermore, the content authoring system enables the user to modify some software items, such as the types of encoding used by one service provider or the selected Internet appliance, etc. Accordingly, the customized device is with some capacities inherited from the ones of the selected predefined general device and with some capacities designated for the selected Internet appliance (step 43).

Next, on the display screen of the personal computer, a new editorial zone or/and a simulator are created or opened according to the customized device (step 44). It is noted that the new editorial zone and the editorial contents therein are limited to the capacities of the customized device. For example, when the new editorial zone and/or the simulator is created, loaded or opened, it is of the size similar as the screen associated with the customized device. That is, if the customized device has the capacity of the screen of the size 160×180 pixels, the editorial zone and/or the simulator for authoring or previewing a specific web page for the selected Internet appliance is also of the size 160×180 pixels. Furthermore, if the customized device has the capacity of supporting the image file format in “JPG” and “GIF”, the image contents used in the specific web page are in the format of “JPG” or “GIF”. Thus, the user authors and/or previews the web page contents in the editorial zone and/or simulator that looks like a hypothetic screen same as the real one of the selected Internet appliance.

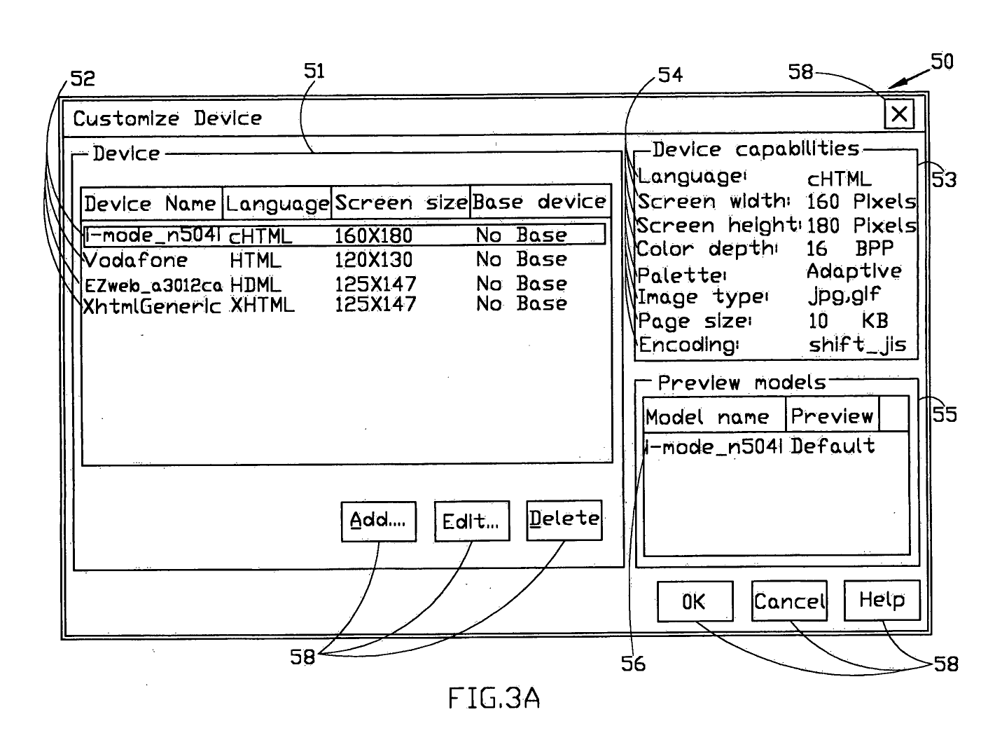

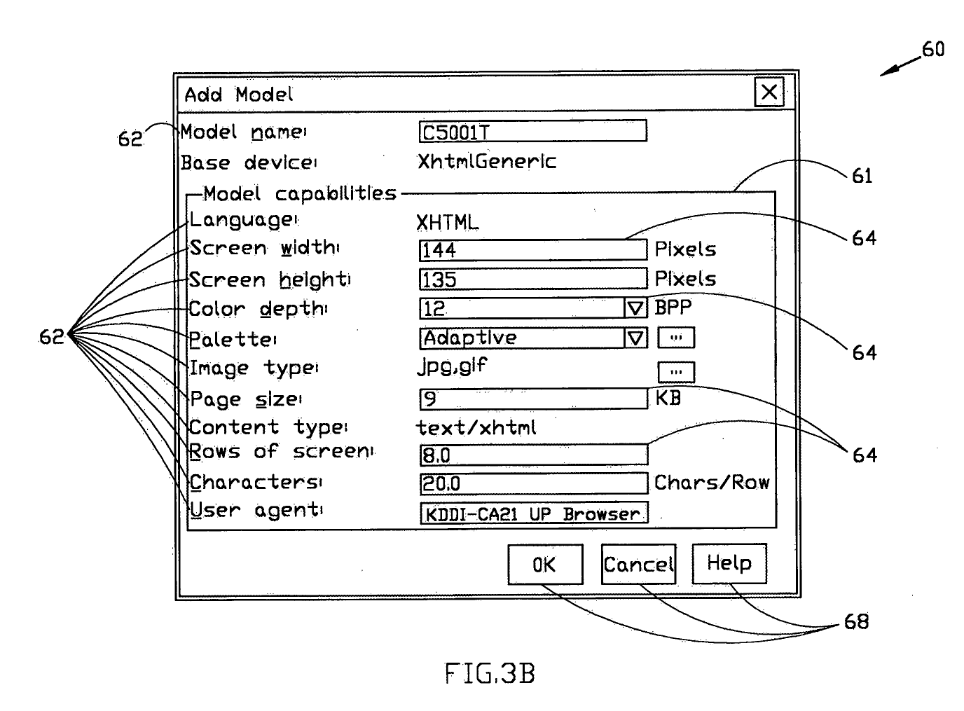

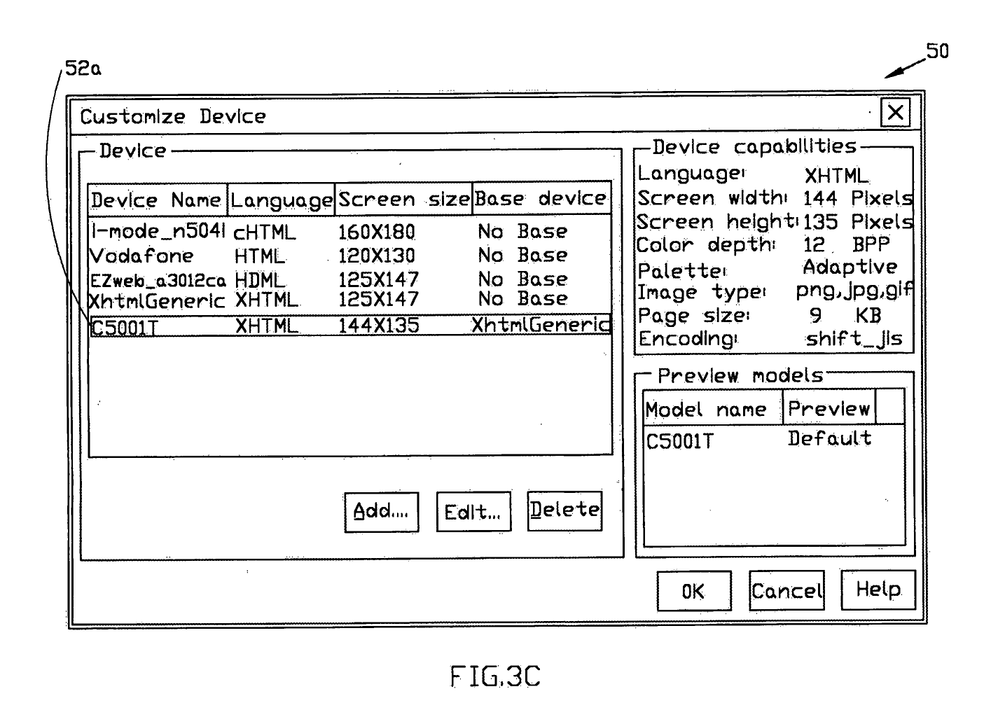

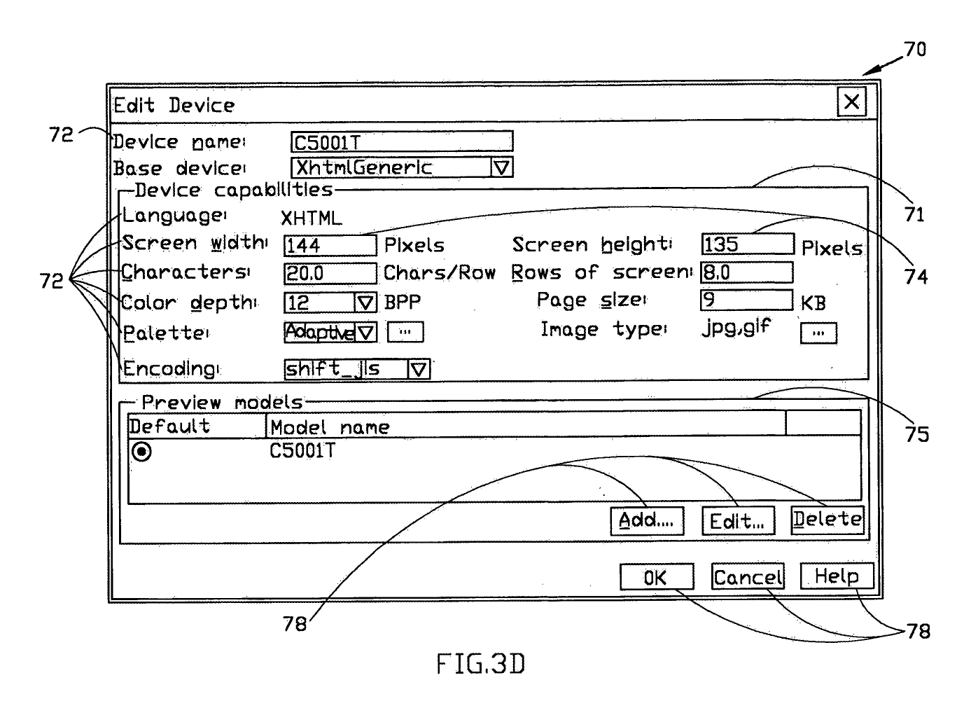

FIGS. 3A to 3D illustrate the displays of the portions of user interfaces for the embodiment in accordance with the present invention. In one embodiment, the content authoring system is setup and stored in the personal computer. A content provider (user) requests to add a customized device and a “customized device” dialog box 50 is popup. In the dialog box 50, the information 52 of predefined general devices is listed on “device zone” portion 51. Once the content provider selects one of them, such as one named as “i-mode_n504i”, the device “i-mode_n504i” is highlighted with some items 54 corresponding to the capacities shown on “device capacities” portion 53. In addition, the “preview models” portion 55 illustrates the information 56 of a device module for previewing in associated with the selected predefined general device. Generally, the device module will be the same as the selected predefined general device. Of course, there are multitudes of controls 58 for controlling the dialog box 50, ensuring and executing the selection for the information 52, and going the next steps, etc.

In performing the addition of another predefined general device by the user, for example, based on the device named as “XhtmlGeneric”, the request for displaying “XhtmlGeneric” is ensured by executing the “Add” control 58. Then an “Add Model” dialog box 60 is popup shown in FIG. 3B. At first in the dialog box 60, the default values 64 of items 62 for the device “XhtmlGeneric” are displayed on the “Model capacities” portion 61. In addition, the name of the device “XhtmlGeneric” is shown as the name of “Base device”. However, the user may nominate the new general device with the “Model name” item 62, such as “C5001T”. Furthermore, the user may modify some values 64 for the new general device named as “C5001T”. The modification method used by the user is not limited to the selection from a pull-down sheet as shown. Any suitable method, such as characters by keying in, is fit into the embodiments of the present invention. It is noted that the values 64 of some items 62, such as “Content type”, are disabled for the user. Of course, there are multitudes of controls 68 for controlling the dialog box 60.

After the close of the dialog box 60, there is the new general device 52a named as “C5001T” shown on the “device zone” portion 51 of the dialog box 50, depicted in FIG. 3C. It is noted that the information 52a is shown with its inheriting from the device “XhtmlGeneric”.

In performing the authoring of one predefined general device by the user, the other dialog box 70 is popup, shown in FIG. 3D. The user can amend or modify the values 74 of the items 72 in the “Device capabilities” portion 71. In addition, the user may change the device module for previewing in “Preview models” portion 75 by using the controls 78. It is noted that the displays in FIGS. 3A to 3D are applied on the creation of both an editorial zone and a simulator, but not limited to.

Although the invention has been described above with reference to particular embodiments, various modifications are possible within the scope of the invention as will be clear to a skilled person.

What is claimed is:

1. A customization method for authoring a web page, the customization method comprising:
providing at least one predefined general device for an Internet appliance, wherein said predefined general device is with a plurality of first capacities associated therewith;
receiving a request for editing at least one value corresponding one of said first capacities;
generating a customized device with a plurality of second capacities, wherein at least one of said second capacities is inherited from at least one of said first capacities and said value is corresponding to at least one of said second capacities; and
displaying an editorial zone for authoring said web page, wherein said editorial zone is corresponding to said customized device and limited to at least one of said second capacities.

2. The customization method according to claim 1, wherein said first capacities comprise a plurality of physical capacities of said Internet appliance.

3. The customization method according to claim 2, wherein said editorial zone is limited to at least one of said second capacities comprising at least one of said physical capacities.

4. The customization method according to claim 1, wherein said first capacities comprise a plurality of network capacities of said Internet appliance.

5. The customization method according to claim 1, wherein said first capacities comprise a plurality of software capacities of a computer server associated with said Internet appliance.

6. The customization method according to claim 1, wherein said Internet appliance has a physical screen with a size same as said editorial zone.

7. The customization method according to claim 1, wherein said Internet appliance is a wireless cell phone.

8. The customization method according to claim 1, further comprising displaying a simulator for previewing said web page, wherein said simulator is corresponding to said customized device and limited to at least one of said second capacities.

9. A customization method for authoring a web page to display on an Internet appliance, the customization method comprising:
providing a plurality of predefined general devices for said Internet appliance, wherein each of said predefined general device is with a plurality of first capacities associated therewith;
receiving a first request for selecting one of said predefined general devices as a base device;
receiving a second request for editing at least one value corresponding one of said first capacities of one said predefined general device;
generating a customized device with a plurality of second capacities, wherein at least one of said second capacities is inherited from at least one of said first capacities and said value is corresponding to at least one of said second capacities; and
displaying at least one of both an editorial zone and a simulator for authoring or previewing said web page, wherein said editorial zone or said simulator is corresponding to said customized device and limited to at least one of said second capacities.

10. The customization method according to claim 9, wherein the step of receiving said first request comprises displaying said plurality of values of said associated first capacities for said selected predefined general device.

11. The customization method according to claim 9, wherein the step of generating said customized device comprises storing said plurality of second capacities.

12. The customization method according to claim 9, wherein said first capacities comprise a plurality of physical capacities of said Internet appliance.

13. The customization method according to claim 9, wherein said first capacities comprise a plurality of network capacities of said Internet appliance.

14. The customization method according to claim 9, wherein said first capacities comprise a plurality of software capacities of a computer server associated with said Internet appliance.

15. A storage device, storing a plurality of programs readable by a media process device, wherein the media process device according to said programs executes the steps comprising:
providing at least one predefined general device for an Internet appliance, wherein said predefined general device is with a plurality of first capacities associated therewith;
receiving a request for editing at least one value corresponding one of said first capacities;
generating a customized device with a plurality of second capacities, wherein at least one of said second capacities is inherited from at least one of said first capacities and said value is corresponding to at least one of said second capacities; and
displaying at least one of both an editorial zone and a simulator for authoring or previewing said web page, wherein said editorial zone or said simulator is corresponding to said customized device and limited to at least one of said second capacities.

16. A customizing system for authoring a web page to display on an Internet appliance, the customizing system comprising:
a plurality of predefined general devices configured for being a base device for the Internet appliance, wherein each said general device has a plurality of associated capacities; and
a customization module for selecting one of said predefined general devices, editing said associated capacities of said selected predefined general device, and generating a customized device based on said selected predefined general device and said associated edited capacities.
